(19) United States
(12) Patent Application Publication
(10) Pub. No.: US 2008/0275761 A1
(43) Pub. Date: Nov. 6, 2008

(54) WINE DATABASE AND RECOMMENDATION SYSTEM

(75) Inventors: Barry S. Seifer, Ann Arbor, MI (US); David Alan Newlin, Larkspur, CA (US); John Manoogian, San Francisco, CA (US)

Correspondence Address: BUTZEL LONG;IP DOCKETING DEPT, 350 SOUTH MAIN STREET, SUITE 300, ANN ARBOR, MI, 48104, US

(73) Assignee: 1821 Wine Company, Inc., Dover, DE (US)

(21) Appl. No.: 12/111,132

(22) Filed: Apr. 28, 2008

Related U.S. Application Data
(60) Provisional application No. 60/914,082, filed on Apr. 26, 2007.

(51) Int. Cl. G06Q 30/00; G06Q 10/00

(52) U.S. Cl. 705/10; 705/28

(57) ABSTRACT

A method for storing wine industry data, consumer preference data, and inventory data for a particular type of wine in a database and using the wine industry data and consumer preference data to provide a personalized wine recommendation comprising obtaining information to identify a bottle of wine, receiving consumer preference data for the bottle of wine, searching the wine industry data based on the consumer preference data and providing a location-based wine recommendation to the consumer.

### CROSS-REFERENCE TO RELATED PATENT APPLICATIONS

This application claims the benefit of, and priority to, U.S. Provisional Patent Application No. 60/914,082, filed Apr. 26, 2007, which is incorporated by reference herein.

### BACKGROUND OF THE INVENTION

The present invention relates generally to a wine database and recommendation system and, more particularly, to a web-enabled and geographically sensitive system and method for storing and sharing information about wine.

The U.S. wine industry lags behind the wine industries in western European countries such as Italy, France, and Spain—countries whose cultures Americans constantly try to emulate. While wine can be a very appealing beverage, it is accompanied by a steep learning curve. The problem is further exacerbated in that the industry in the United States incorrectly assumes that consumers have a high-level of interest in wine, and therefore ought to be willing to invest time and attention reading, searching and learning its sometimes arcane, specialized language. In reality, however, wine is a relatively low-involvement purchase for the vast majority of consumers. Many rely on numerical ratings posted at the wine store and trust those ratings. But those ratings can undermine consumer confidence and reinforce inaccurate or misguided notions. For example, ratings lead many consumers to believe that wine can be objectively rated and therefore higher ratings equate to better flavor since those ratings are by experts who are the most qualified and expert judgment is more accurate than personal judgment. Further, consumers are misguided in thinking that top-rated wines are the only ones worth purchasing and drinking or that the best wine is scarce and unaffordable or that unrated wines are inferior and worth less than rated wines. Unfortunately none of this is necessarily true.

Those ratings do not take a consumer's particular likes and dislikes into account and therefore consumers get discouraged when they do not enjoy a wine that is highly ranked and are lead to believe that they must not like wine. Additionally, U.S. consumers have not learned that it is okay to make a subjective decision regarding wine and learn what tastes they prefer. This phenomenon, perhaps, is the reason that U.S. per capita wine consumption is about 20% of our western European counterparts. Wineries and retail stores desire for that percentage to rise considerably, but have not been able to change consumers' trepidation about purchasing wine. Small wineries especially desire a change in the wine shopping experience because they do not necessarily have the resources to take on a large marketing campaign and increase brand name awareness. Since most consumers will make quick decisions based on brand recognition and not on their particular likes and dislikes, the inability to market and create name recognition is a detriment to smaller wineries.

Consumers prefer an interactive shopping experience, a preference that has increased with the wealth of information available via the Internet. Even more recently, consumers expect an on-the-go solution as many will quickly research purchases on their Internet enabled mobile device, such as a smart phone. Having such vast amounts of information at their fingertips allows consumers to conduct research and purchase the best product for him/herself based on that research. Unfortunately, the information available on the Internet regarding wine is still very sophisticated and not very consumer friendly, making one feel as if they do not have the experience necessary to sift through the information and find the best bottle of wine for their tastes. Further, the information is not geared towards the consumers' likes and dislikes and instead again focuses on the objective opinions of the experts, thereby ignoring that wine is not a one-fit solution for all.

Additionally, the solitary and intimidated feeling one gets upon walking into a wine store and standing alone among a vast number of bottles, afraid of looking like a novice, is quite the opposite of the shopping experience most consumers prefer. Consumers may experience a glass of wine at a restaurant, and vow to remember the name in order to make a future purchase. Oftentimes, however, the name becomes forgotten or the consumer cannot find the bottle at a local store, gives up, and then resorts to purchasing a well-known brand name simply because they recognize it or someone else has mentioned it to them, only to discover that they do not enjoy that particular wine but not knowing how to find one they will enjoy. This results in many people believing that they do not like wine, when in fact the problem is that they have not felt comfortable experimenting to discover what tastes they prefer.

Therefore, there is a need in the marketplace for a system to provide consumers of varying budgets, wine knowledge, and levels of interest with an interactive, on-the-go personalized wine experience that will aide them in sharing information about wine, provide them with recommendations based upon their tastes and/or location. There is also a need for a system that allows all the players in the wine industry—from the wineries to the consumers—to share information, therefore taking some of the intimidation of the wine purchasing process out of the equation. There is also a need for a system that allows consumers to easily track and record the wines that they've tasted such as that glass of wine they enjoyed in a restaurant last night or that great bottle of wine they purchased years ago and enjoyed, but is likely to be forgotten if not recorded. There is a further need for a system that takes this information and makes a suggestion for the consumer that the consumer feels he/she can trust. There is also a need for a system that provides a more effective, low cost marketing channel for smaller producers so as to raise brand awareness and encourage consumers to develop their own wine palate by venturing outside of those one or two mainstream brand names that they purchase just because they recognize the name. Finally, there is also a need for a system that provides valuable data for the wine industry to evaluate and make strategic decisions.

### SUMMARY OF THE INVENTION

3. The present invention concerns a system and method, of providing a web and mobile-enabled wine community for use by every player in the wine business—from wineries to retailers to consumers. The system and method use wine industry data, consumer preference data and location data stored in a database to provide consumers with personalized location-based wine recommendations. In one embodiment there is a web-based wine database system for accessing wine data, modifying wine data, and receiving personalized wine recommendations comprising an application server, a database storing wine data electronically connected to the application server; and a wireless interface for connecting to the application server and accessing the wine data stored in the database. In another embodiment there is a method for storing wine industry data, consumer preference data, and inventory data for a particular type of wine in a database and using the wine industry data and consumer preference data to provide a personalized wine recommendation comprising obtaining information to identify a bottle of wine, receiving consumer preference data for the bottle of wine, searching the wine industry data based on the consumer preference data; and providing a wine recommendation.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is an exemplary diagram in accordance with an embodiment of the present invention;

FIG. 2 is an exemplary diagram in accordance with an embodiment of the present invention;

FIG. 3 is an exemplary diagram in accordance with an embodiment of the present invention;

FIG. 4 is an exemplary diagram in accordance with an embodiment of the present invention;

FIG. 5 is a block diagram in accordance with an embodiment of the present invention; and

FIG. 6 is a block diagram in accordance with an embodiment of the present invention.

### DESCRIPTION OF THE PREFERRED EMBODIMENT

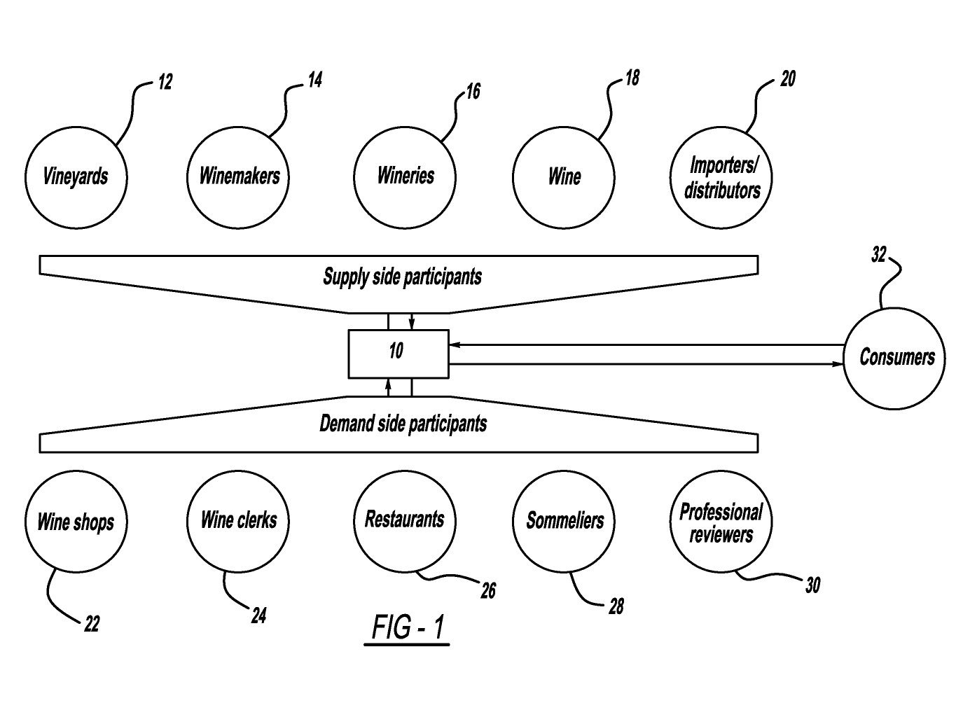

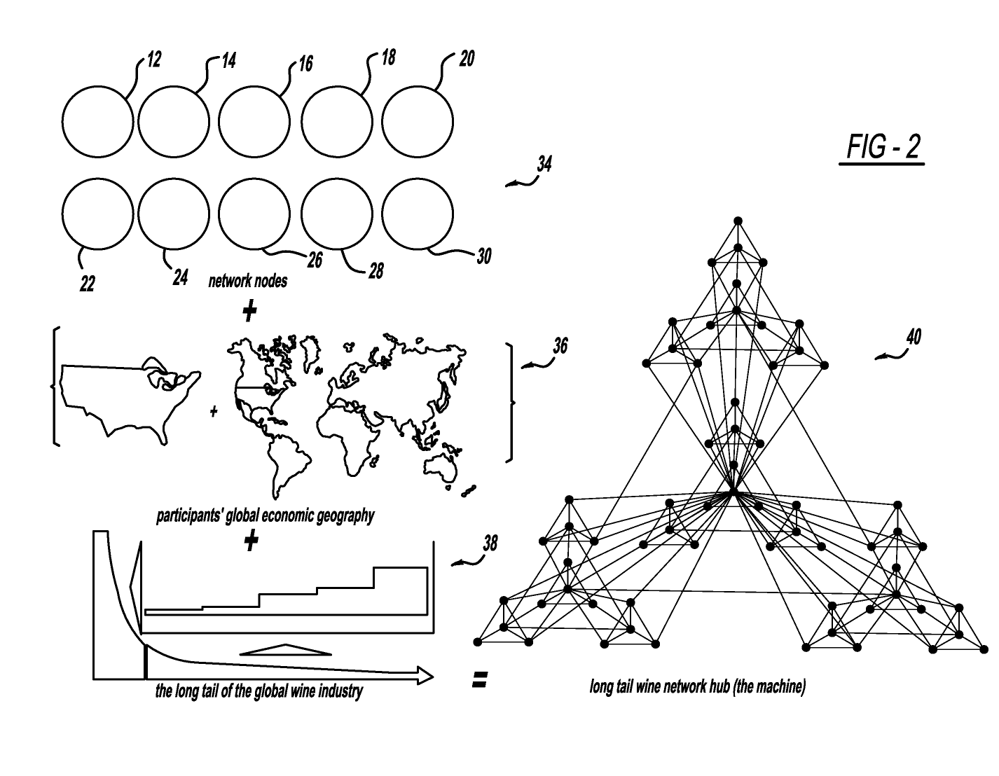

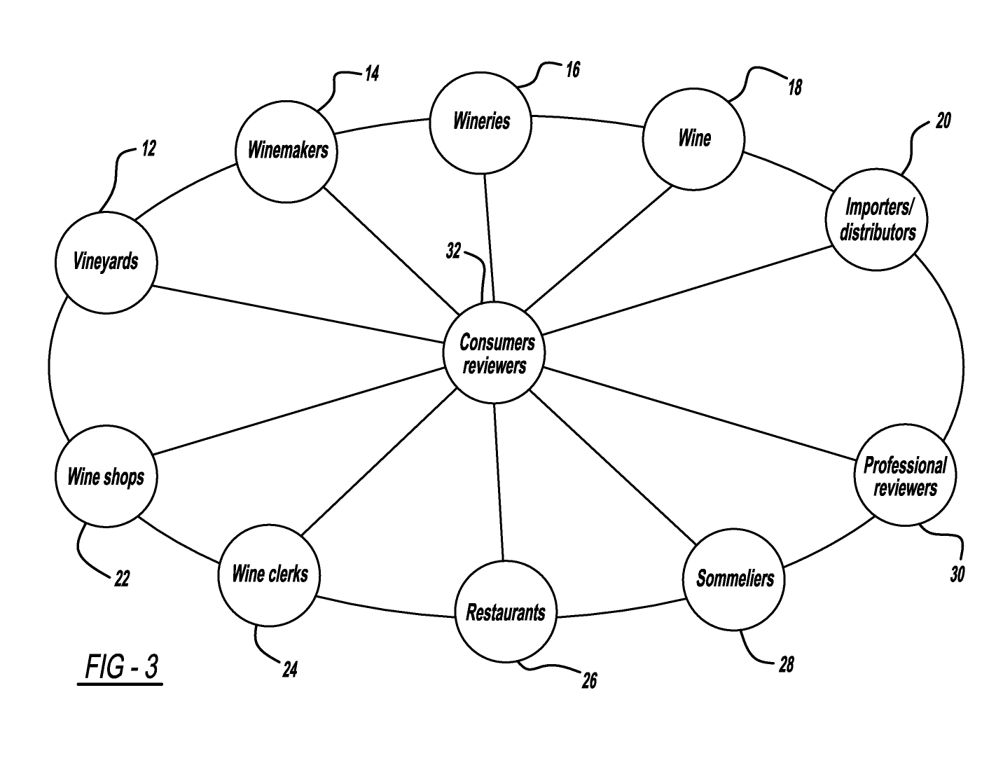

The present invention concerns a system and method of providing a centrally-managed, web and mobile-enabled wine community for use by every player in the wine business—from wineries and distributors to retailers and consumers—and that provides benefits to everyone involved. Referring to FIG. 1, the present invention provides a central system 10 that links supply side participants of the wine industry such as vineyards 12, winemakers 14, wineries 16, wine 18, and importers/distributors 20 with demand side participants such as wine shops 22, wine clerks 24, restaurants 26, sommeliers 28, and professional reviewers 30 with consumers 32. Referring to FIG. 2, by combining the demand side, supply side and consumer participants in one system as network nodes at 34 with the participants' global economic geography at 36 and the wineries of the global wine industry at 38, a large comprehensive wine network hub 40 is created. This hub 40 is the “machine” that provides personalized wine recommendations for consumers 32 and market advantages for industry participants at a level never before seen. At its highest level, the system and method of the present disclosure provides a consumer-centered wine industry system 10 and network hub 40 (as shown in FIGS. 2 and 3) that provides personal, geographically relevant wine guidance available to consumers 32 via the Internet or more specifically a personal digital device that provides an Internet interface such as a web-enabled smart phone. The present invention preferably knows where you are and what wines are available where you are, reads data matrix symbols on wine bottles, correlates and filters consumer ratings and preferences with supplier data about what exactly is in the bottle of wine you like and how that result was achieved, along with data from your friends and/or your selected demand-side experts, compares results with inventory geodata (what is available at your location) and guides you to personalized suggestions of what wines you are likely to enjoy the most from what is available.

The result is a personal, geographically relevant wine guidance available when consumers 32 need it the most—when they are shopping and selecting wine in a shop or selecting wine at a restaurant. The present invention is an easy to use, relevant, intuitive and always-available application that connects consumers 32 to one another. Moreover, the invention makes the wine experience enjoyable and fearless by reducing uncertainty and doubt associated with making a mistake, saving time, creating comfort and security; and thereby encouraging exploration, while creating and strengthening social connections around a common interest.

While on its surface the present invention provides virtually effortless wine purchasing information for consumers, the present invention provides value to the entire wine industry. For wine producers, distributors and retail participants, the present invention offers a unique, channel-spanning opportunity that provides a more effective, low-cost marketing and communications platform that connects supply side participants with demand side participants. The present invention also enables producers, distributors, and retail participants to pinpoint types of consumers and grow markets based on consumer trends in different geographic locations.

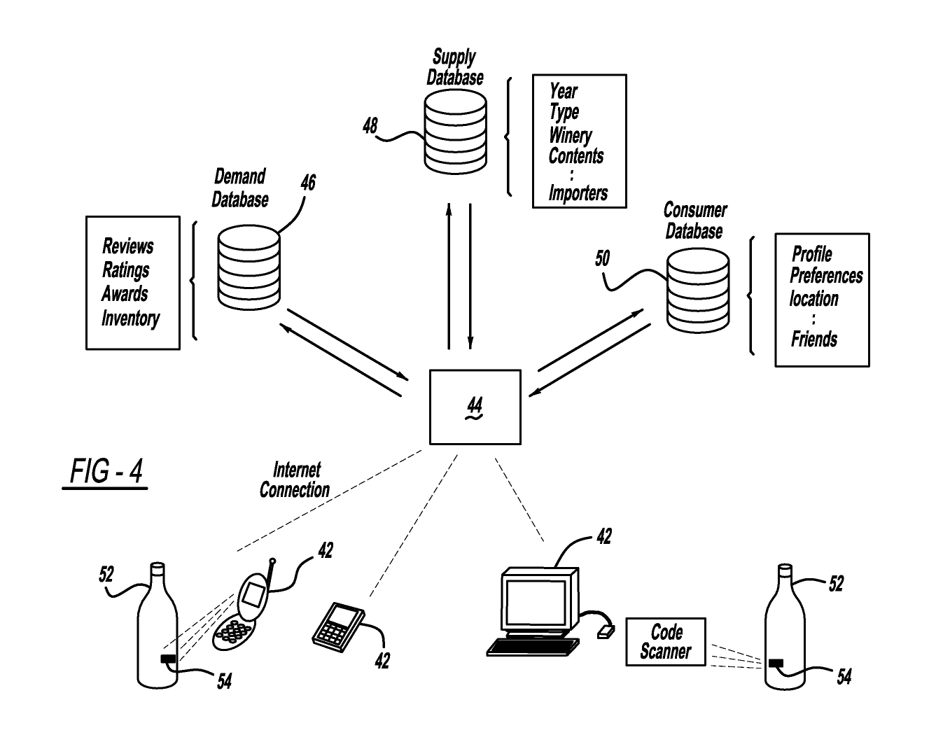

Referring now to FIG. 4, the structure of the system 10 as contemplated in the preferred embodiment of the present invention preferably includes an Internet enabled device 42, an application server 44 and three databases—a demand side database 46, a supply side database 48 and a consumer database 50. The internet enabled device 42 can be any type of capable device such as a computer or a smart phone. The internet enabled device 42 preferably communicates with the application server 44 via the Internet (wireless or wired) and/or SMS messaging.

According to the preferred embodiment of the present invention, the application server 44 runs the software necessary to serve as the intermediary to control interaction between the user and the information in the databases 46, 48, 50. The application server 44 software also manipulates the data in the databases 46, 48, 50 in response to the user's actions. Each of the databases 46, 48, 50 may store many different types of information as required for the carrying out of the invention. For example, the supply side database 48 contains information related to the supply side of the wine industry. The supply side of the industry typically includes vineyards 12, winemakers 14, wineries 16, and importers/distributors 20 as shown in FIG. 1. The type if information stored in the supply side database 48 preferably includes the hard information about the wine such as vintage year, type of wine, winery, alcohol content, vineyard yield, contents of the wine, type of barrels used, geographical location where the grapes were grown, temperature data for that year, importers/distributors, etc.

As shown in FIG. 4, the demand side of the industry typically includes wine shops 22, wine clerks 24, restaurants 26, sommeliers 28, and professional reviewers 30. Therefore, the demand side database 46 preferably includes information such as reviews, ratings, awards received, inventory status, etc. Finally, the consumer database 50 stores information related to the consumers 32 and may involve information including default location, profile, recommendation preferences, personal wine references, lists of preferred friends/reviewers, etc. In the preferred embodiment of the present invention, the application server 44 interacts with these different databases 46, 48, 50 and pulls, manipulates, and aggregates information contained therein to provide a vast array of information. Most specifically, the data is mined to provide the consumer 32 with a wine recommendation based on current location. One skilled in the art, however, will appreciate that since the types of data that could be stored in the databases 46, 48, 50 is endless, the types of data that can be provided to any user of the system is also endless. Some examples include maps to locations with particular wines, maps showing where the grapes were grown, top rated wines by consumers, popular wines in particular geographic regions, and most popular wines at a particular store or restaurant. These examples, however, are not intended to be limiting on the scope of the present invention.

The preferred embodiment of the present invention contemplates each bottle of wine 52 having an identification label 54 or device (not shown) capable of relaying information about the bottle of wine 52. Examples of such labels 54 or devices include bar codes or 2 or 3D data matrices such as semacodes or QR Codes®. It is also anticipated that actual devices such as radio frequency identification (RFID) chips (not shown) could be located on the bottle, in the cork or on the bottle cap. The level of information contained in the identification label or device is customizable but would preferably contain at least vintage, wine type, and winery. Additionally, the data may contain a unique number to identify further levels of detail such as a particular batch, barrel, vineyard, part of a vineyard, etc. Alternatively, the system of the present invention could allow for use of bottles not marked with a identification tag and instead require the user to manually enter the year, type of wine and winery to identify the bottle of wine. In yet another alternative embodiment, the bottle of wine may contain a unique, proprietary number that relays this information to the system 10.

While the actual configuration of the system 10 is important, one should appreciate that the functionality of the system is most important and strongly dictates the physical configuration of the system. As such, one skilled in the art will appreciate that the preferred embodiment of the system may easily be modified from the disclosure above in accordance with the intended functionality and data manipulation of the platform. It is anticipated that the organization of the system 10, especially the databases 46, 48, 50 and the information contained therein may be altered to achieve particular desired functionality and such modification does not stray from the spirit or scope of the present disclosure. For example, there could be more databases or fewer databases. Additionally, the databases 46, 48, 50 may include additional information about the wine industry and/or consumers.

In accordance with the preferred embodiment of the present invention, different types of users will be granted unique access rights to only be able to edit database information that they have direct responsibility for. For example, a consumer 32 can edit information in the consumer database 50 such as his/her personal profile, wine reviews, and search parameters but cannot edit the information about a particular wine in the supply database 48. Similarly, a winery 16 could edit information about its wines in the supply database 48 but could not edit a consumer's 32 review of its wines. One skilled in the art will appreciate that editing and searching capabilities and access to certain types of data may be restricted in accordance with the particular goals of the system 10.

As an example of a consumer 32 using the system 10, referring to FIG. 6, a consumer 32 is out at a restaurant, enjoying a bottle of wine. In step 64, he accesses the system and then in step 66 he uses the camera on his smart phone 42 to scan the code 54 on the bottle 52. The system 10 recognizes the code and in step 68 allows the consumer 32 to enter a rating for the wine. Finally, in step 70, the system 10 stores the consumer's updated information in the consumer database 50. Alternately, the consumer 32 could choose to scan the label 54 and connect to the system 10 at a later time to enter the information. This process is similar no matter what type of Internet enabled device the consumer 32 is using.

The preferred embodiment of the present invention preferably allows the users to customize their information and data results in any number of ways so that each user's profile is unique. For example, a consumer 32 can preferably personalize the system to store his/her own thoughts and reviews of different wines and rate the wine according to a predefined rating system. The user may also enter other notes such as where the wine was bought, how much was paid, etc. The system 10 also preferably allows a consumer 32 to create a network of other consumers 32 and/or professional reviewers 30 in order to receive reviews and recommendations from those other users. The system 10 may allow a user to weigh the users in their own personal network, therefore allowing heavily weighted users to have more influence than lightly weighted users in the network. The information entered into a consumer's profile will allow the system to make intelligent recommendations on bottles of wine for the consumer to try. Such recommendations may be based on numerous factors, such as recommending new wines based on other users with similar ratings on bottles of wine or recommending wines based on wines rated highly by others in the user's network. A person with ordinary skill in the art will appreciate that the methods of providing recommendations are numerous and not limited by the few examples provided herein.

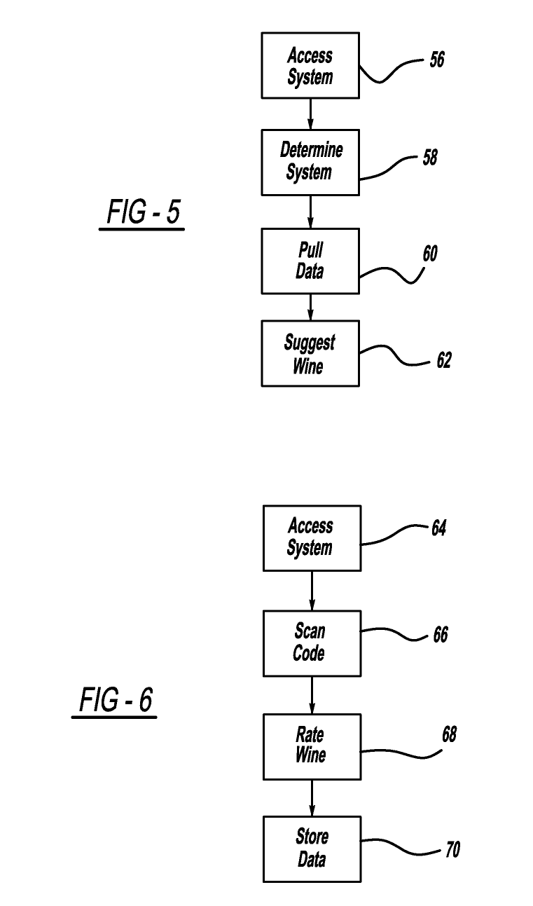

Preferably, the system 10 is able to determine the consumer's 32 location by methods such as GPS, cell tower triangulation, or manual input by the user and then intelligently suggest a wine available at or close to the consumer's current location. For example, referring to FIG. 5, in step 56 a consumer 32 arrives at a wine shop 22 and uses her smart phone 42 to access the system 10. In step 58, the system determines her location. Then, in step 60 the system 10 searches the inventory of the wine store 22 in the demand database 46 and searches the wines in the supply database 48 to find wines that the store 22 carries and that have similar qualities to other wines the consumer 32 has enjoyed according to her information in the consumer database 50.

Alternatively, the system 10 may provide the consumer 32 with suggested wines available in her general area and provide information as to what stores and/or restaurants carry the wine. The system 10 may also provide the consumer 32 with the information needed to purchase a particular bottle of wine in other locations such as providing a list of online vendors where the wine may be purchased or provide information to contact the winery about purchasing the wine.

The system 10 may further include the ability of consumers 32 to indicate their interest in splitting a case of a particular wine so that the users can organize the purchase of cases instead of individual bottles. The system may further include features in which the system is used for such group ordering such that shipping, payment, etc. may be done on an individual basis even though the group is splitting a case.

The system 10 may additionally include the option for a consumer 32 to send an “interest message” to a local wine retailer that would inform the retailer of the user's interest in a particular wine. Upon receiving one such message or maybe upon receiving multiple such messages for a particular wine, the retailer would know to order some stock of that wine and then would have the ability to inform the user(s) of its availability.

In yet another feature, the system 10 could suggest a wine that not only pairs with the consumer's particular tastes but that would also pair with the particular type of food the consumer 32 is eating. The system 10 could also allow consumers 32 to allow people in their network to access recommendations for them, that way if one friend wanted to purchase a bottle of wine for the other, she could access the system and get recommendations of what wine her friend would enjoy the most. The system 10 could also be used to reserve bottles of win in the wine futures market and then even trade those futures. Additionally, functionality could be added to the system 10 to allow a consumer 32 to ear mark a certain portion of their purchases for charitable causes. These are just a few examples of additional functionality that could be added to the system 10 without straying from the scope of the present disclosure.

In another embodiment of the present invention, the system 10 could be a stand-alone or be incorporated into a social software application such as a mobile social software (MoSoSo) application. In this embodiment, the system 10 operates as a multiplayer online semantic search game (MMO) wherein the consumer participants are at the center, controlling the game while geodata drives the game. Each consumer participant controls and filters the experience. From the consumer standpoint, he/she is not playing a game, but instead is using a tool.

In yet another alternate embodiment, the system 10 may include the feature wherein stores and/or restaurants can relay information directly to the consumer 32 via a short distance wireless protocol such as Bluetooth® or ZigBee®. Such information could include up-to-date inventory or even store specials.

One skilled in the art will appreciate that the present disclosure discloses an invention that combines all parties to the wine industry to create a comprehensive personalized tool that is advantageous for all involved. Certain features mentioned are for example only and may be modified or additional features added while still staying within the scope of this disclosure. Additionally one will appreciate that while the wine industry is utilized as an example in this disclosure that the system and method as disclosed herein could be utilized in other industries without straying from the scope of this invention.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An internet-based database stored digitally on a computer system for providing personalized location-based wine suggestions to users comprising:
unique consumer data;
retail data; and
wine data.

2. The database of claim 1 further comprising geographic inventory data to provide personalized location-based wine suggestions.

3. A web-based wine database system for accessing wine data, modifying wine data, and receiving personalized wine recommendations comprising:
an application server;
a database for storing wine data and electronically connected to the application server; and
a wireless interface for connecting to the application server and accessing, modifying, and receiving the wine data stored in the database.

4. The system of claim 3 further comprising a bottle of wine and an identification tag on the bottle of wine for identifying the bottle of wine in the system.

5. The system of claim 3 wherein the identification tag is a data matrix.

6. The system of claim 3 wherein the identification tag is a radio frequency identification (RFID) tag.

7. The system of claim 3 wherein the database contains data about a bottle of wine.

8. The system of claim 3 wherein the database contains wine inventory data, the wireless interface sends location data to the application server and the database system provides personalized wine recommendations based on the wine inventory data and the location data.

9. A method for storing wine industry data, consumer preference data, and inventory data for a particular type of wine in a database and using the wine industry data and consumer preference data to provide a personalized wine recommendation comprising:
obtaining information to identify a bottle of wine;
receiving consumer preference data for the bottle of wine;
searching the wine industry data based on the consumer preference data; and
providing a wine recommendation.

10. The method of claim 9 wherein the step of obtaining information to identify a bottle of wine further comprises the steps of:
scanning an identifying label containing bottle data on a bottle of wine with a digital device;
sending the bottle data to the database; and
identifying the type of wine by matching the bottle data with the wine industry data in the database.

11. The method of claim 9 wherein the step of providing a wine recommendation further comprises the steps of:
receiving location data from a digital device;
searching the wine industry data based on the location data; and
matching the consumer preference data and wine industry data with the location data.
